(19) United States
(12) Patent Application Publication
(10) Pub. No.: US 2025/0238912 A1
(43) Pub. Date: Jul. 24, 2025

(54) IMAGE PROCESSING APPARATUS, CONTROL METHOD FOR IMAGE PROCESSING APPARATUS, AND STORAGE MEDIUM

(71) Applicant: CANON KABUSHIKI KAISHA, Tokyo (JP)

(72) Inventor: Daisuke NAGAO, Saitama (JP)

(21) Appl. No.: 19/006,374

(22) Filed: Dec. 31, 2024

(30) Foreign Application Priority Data
Jan. 22, 2024 (JP) 2024-007426

(51) Int. Cl. G06T 7/00

(52) U.S. Cl. CPC G06T 7/0002; G06T 2207/20076; G06T 2207/20081

(57) ABSTRACT

A mechanism that, in a case of being determined that an obtained image is an image generated based on a learning model, assigns, to the obtained image, an identification image indicating that the obtained image is an image generated based on a learning model is provided. An image processing apparatus includes an obtaining unit configured to obtain an image, a determining unit configured to determine whether or not the image obtained by the obtaining unit is an image generated based on a learning model, and an assigning unit configured to, in a case of being determined by the determining unit that the image obtained by the obtaining unit is an image generated based on the learning model, assign, to the image obtained by the obtaining unit, an identification image indicating that the image obtained by the obtaining unit is an image generated based on the learning model.

### BACKGROUND OF THE INVENTION

### Field of the Invention

The present invention relates to an image processing apparatus, a control method for the image processing apparatus, and a storage medium.

### Description of the Related Art

In recent years, image generation technology using artificial intelligence (AI) has become widespread. This makes it possible for individuals to easily generate realistic images. On the other hand, there have been cases where AI-based image generation technology (the image generation technology using AI) has been used maliciously, which has become a problem. For example, photographs or the like of fictitious events, fictitious incidents or fictitious accidents about real people, real facilities or the like have been fabricated. In order to prevent such misuse of the AI-based image generation technology, various countries are rushing to establish legislation, development guidelines, and the like regarding AI-generated contents. As part of this legislation, legislation or the like is being considered that would require the AI-generated content to clearly state that it has been generated by AI. In addition, in the future, it is highly likely that a clear distinction will be required between the AI-generated contents and contents other than the AI-generated contents. Japanese Laid-Open Patent Publication (kokai) No. 2006-211477 has disclosed an image forming apparatus that detects copyright-related read-prohibited information such as copyright marks and/or logos from image data of banknotes, securities, or the like, which are generally prohibited from being copied, and assigns the detected information to the image data as information indicating that copying is prohibited.

However, in the image forming apparatus disclosed in Japanese Laid-Open Patent Publication (kokai) No. 2006-211477, even in the case that information regarding whether or not it is an image that has been generated by using AI needs to be assigned, the assignment will not be performed.

### SUMMARY OF THE INVENTION

The present invention provides a mechanism that, in a case of being determined that an obtained image is an image generated based on a learning model, assigns, to the obtained image, an identification image indicating that the obtained image is an image generated based on a learning model.

Accordingly, the present invention provides an image processing apparatus comprising an obtaining unit configured to obtain an image, a determining unit configured to determine whether or not the image obtained by the obtaining unit is an image generated based on a learning model, and an assigning unit configured to, in a case of being determined by the determining unit that the image obtained by the obtaining unit is an image generated based on the learning model, assign, to the image obtained by the obtaining unit, an identification image indicating that the image obtained by the obtaining unit is an image generated based on the learning model.

Further features of the present invention will become apparent from the following description of exemplary embodiments with reference to the attached drawings.

### BRIEF DESCRIPTION OF THE DRAWINGS

FIG. 1 is a block diagram that shows a hardware configuration of an image processing system according to a first embodiment.

FIG. 2 is a block diagram that shows a hardware configuration of an AI image generation server.

FIG. 3 is a block diagram that shows a hardware configuration of a general purpose terminal.

FIG. 4A is a flowchart that shows a processing executed by the general purpose terminal, and FIG. 4B is a flowchart that shows a processing executed by the AI image generation server.

FIG. 5 is a flowchart that shows a processing executed by an AI image generation server according to a second embodiment.

FIG. 6A and FIG. 6B are diagrams that show examples of an image of image data.

FIGS. 7A, 7B, 7C, and 7D are diagrams that show examples of variations of an image of image data.

FIG. 8 is a block diagram that shows a hardware configuration of a general purpose terminal according to a third embodiment.

FIG. 9 is a flowchart that shows a processing (an AI image identifying processing) executed by the general purpose terminal according to the third embodiment.

FIG. 10 is a flowchart that shows a processing (an AI image notifying processing) executed by the general purpose terminal according to the third embodiment.

### DESCRIPTION OF THE EMBODIMENTS

The present invention will now be described in detail below with reference to the accompanying drawings showing embodiments thereof.

Hereinafter, respective embodiments of the present invention will be described in detail with reference to the drawings. However, the configurations described in the following respective embodiments are merely examples, and the scope of the present invention is not limited by the configurations described in the following respective embodiments. For example, each part (each unit or each component) constituting the present invention can be replaced with a part (a unit or a component) having any configuration capable of performing similar functions. In addition, any component(s) may be added. Moreover, it is also possible to combine any two or more configurations (features) of each embodiment.

### First Embodiment

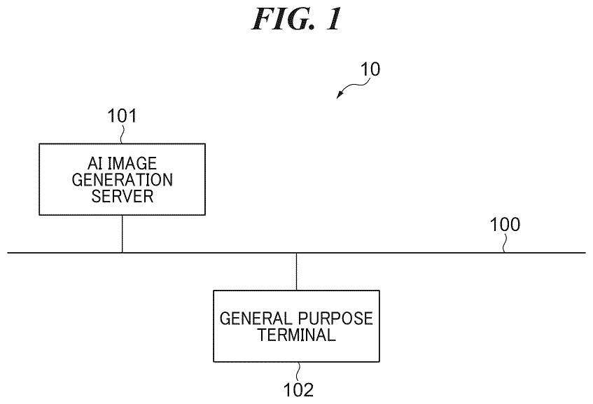

A first embodiment will be described below with reference to FIGS. 1 to 4B. FIG. 1 is a block diagram that shows a hardware configuration of an image processing system according to the first embodiment. As shown in FIG. 1, an image processing system 10 includes an AI image generation server 101 and a general purpose terminal 102, which are connected to each other via a network 100 so as to be able to communicate with each other. The AI image generation server 101 is configured by an information processing apparatus. The AI image generation server 101 is able to generate information based on a learning model (a generating step). In the present embodiment, the information is image data of a still image or a moving image (a video), but is not limited to this and may be, for example, audio data (voice data), text data, or the like, or may be data that includes at least one piece of these data. Hereinafter, generating image data based on a learning model (including a trained model) may be referred to as “AI image generation”. This image data is transmitted to the general purpose terminal 102. The general purpose terminal 102 is an apparatus capable of performing various kinds of processing with respect to the image data transmitted from the AI image generation server 101. The general purpose terminal 102 is not particularly limited, and may be, for example, a desktop type personal computer, a notebook type personal computer, a tablet terminal, a smartphone, or the like.

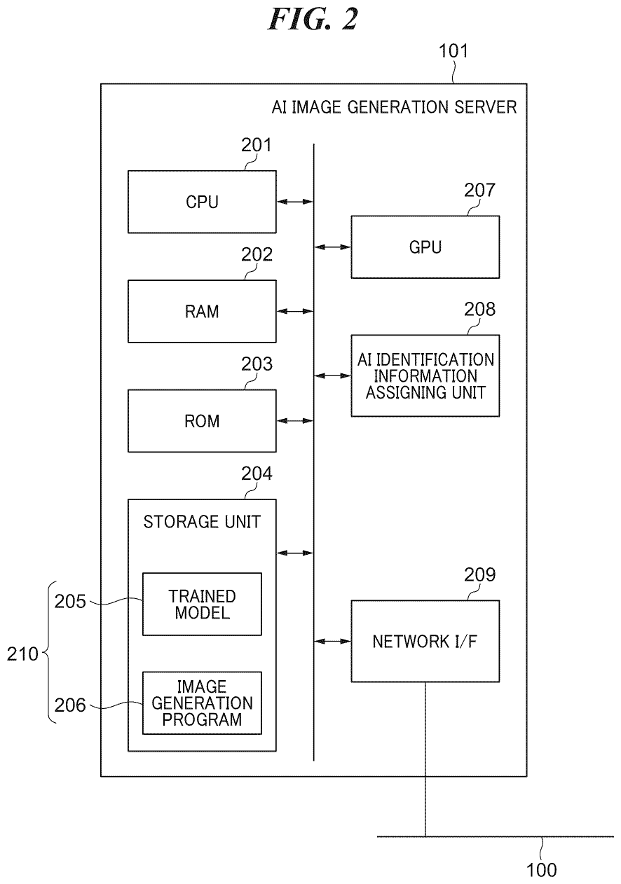

FIG. 2 is a block diagram that shows a hardware configuration of the AI image generation server. As shown in FIG. 2, the AI image generation server 101 includes a central processing unit (a CPU) 201, a random access memory (a RAM) 202, a read only memory (a ROM) 203, a storage unit 204, a graphics processing unit (a GPU) 207, an AI identification information assigning unit (an information assigning unit) 208, and a network interface (a network I/F) 209. The CPU 201 is a computer that controls the operations of the AI image generation server 101 based on a program that has been loaded into the RAM 202. The ROM 203 is a boot ROM in which, for example, a boot program and the like of the image processing system 10 have been stored. In addition, the ROM 203 also stores, for example, programs, etc., for causing the CPU 201 to execute the respective units of the AI image generation server 101 and the respective means of the AI image generation server 101 (a control method for the information processing apparatus). The storage unit 204 is a non-volatile device configured by a hard disk drive (an HDD), a solid state drive (an SSD), or the like. The storage unit 204 stores a trained model 205, an AI image generation program 206, and the like, which are used in the AI image generation. In the present embodiment, the trained model 205 and the AI image generation program 206 function as a generating unit (a generating means) 210 that performs the AI image generation. It should be noted that, for the AI image generation, it is possible to use any trained model 205 and an existing AI image generation program 206 such as Stable Diffusion, but the AI image generation is not limited to use the any trained model 205 and the existing AI image generation program 206 such as Stable Diffusion. The trained model 205 and the AI image generation program 206 are loaded into the RAM 202 and executed by the CPU 201. The technique related to the AI image generation is a publicly-known technique, so it will be omitted here.

The AI image generation is executed in response to a request for the AI image generation (an AI image generation request) from the general purpose terminal 102. The CPU 201 issues an instruction to the GPU 207 so that the GPU 207 responds to the AI image generation request. The GPU 207 performs an AI image generation processing in accordance with this instruction. As a result, image data is generated. The image data includes identification information that is capable of identifying that the image data is image data generated by the AI image generation, i.e., that the image data is image data generated based on a learning model. The assignment of the identification information with respect to the image data (an information assigning step) is performed by the AI identification information assigning unit 208. The image data to which the identification information has been assigned is transmitted from the network I/F 209 via the network 100 to the general purpose terminal 102, or is stored in the storage unit 204. It should be noted that the network I/F 209 is connected to the network 100 and is responsible for inputting and outputting various types of information. The connection between the network I/F 209 and the network 100 may be wired or wireless.

The identification information to be assigned to the image data is not particularly limited, and examples thereof include information regarding that the image data is output data outputted from the trained model 205, and information regarding input data to be inputted into the trained model 205 when the output data is outputted. Other examples of the identification information include the trained model 205, a program using the trained model 205, information regarding a probability of a likelihood that the image data is image data generated based on the trained model 205, information regarding the AI image generation request, etc. In addition, at least one of these is assigned as the identification information. By performing this assignment, it is possible to identify that the image data is image data generated by the AI image generation. In the case that the entire image of the image data is not an AI-generated image but only a part of the image of the image data is an AI-generated image, the identification information may include information for identifying the AI-generated image portion. The information for identifying the AI-generated image portion may be indicated, for example, by the coordinates of the top left and the bottom right of the image of the image data, or may be pixel information that constitutes the AI-generated image portion. It should be noted that in addition to the identification information, for example, information regarding whether or not the image data has been generated based on the trained model 205 certified by a right holder, and information regarding whether or not the image data itself has been certified by the right holder may be assigned to the image data. In addition, for example, information included in the AI image generation request from the general purpose terminal 102, and information regarding copyright in the case that image data generated by the AI image generation is subject to copyright may be assigned to the image data. Such assignment of other information is also performed by the AI identification information assigning unit 208. The image data includes image main body data, which is main information visualized by an image, and metadata, which is attendant information regarding the image main body data. The AI identification information assigning unit 208 is able to assign the identification information to one of the image main body data and the metadata. In the present embodiment, it is assumed that the AI identification information assigning unit 208 assigns the identification information to the metadata. It should be noted that, the assignment of the identification information to the image main body data and the assignment of the identification information to the metadata may be switchable by an operation for the AI identification information assigning unit 208, or one of the two may be predetermined in the program.

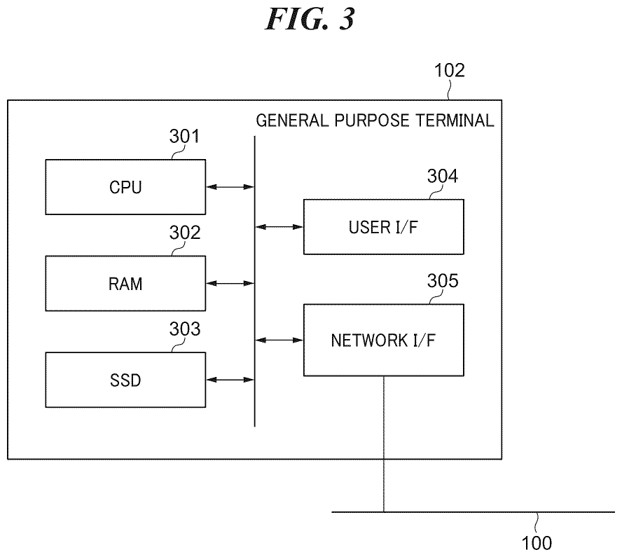

FIG. 3 is a block diagram that shows a hardware configuration of the general purpose terminal. As shown in FIG. 3, the general purpose terminal 102 includes a CPU 301, a RAM 302, an SSD 303, a user I/F 304, and a network I/F 305. The CPU 301 controls the operations of the general purpose terminal 102 based on a program that has been loaded into the RAM 302. The SSD 303 stores various kinds of programs and the like. These programs also include, for example, system programs, an AI image generation application, etc. The user I/F 304 includes, for example, a display, a touch panel, a keyboard, a mouse, and the like, and performs input/output processing for a user. The network I/F 305 is connected to the network 100 and is responsible for inputting and outputting various types of information. The connection between the network I/F 305 and the network 100 may be wired or wireless. It should be noted that the general purpose terminal 102 may have, for example, a telephone function, a camera function, and the like.

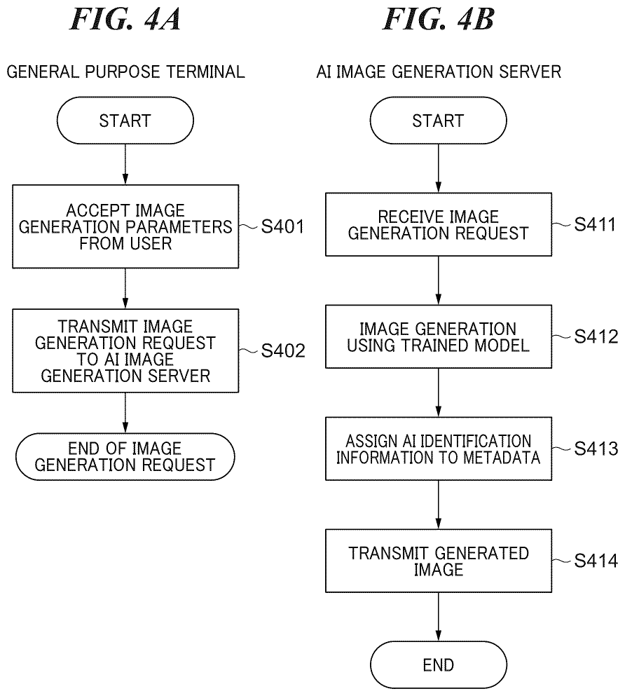

FIG. 4A is a flowchart that shows a processing executed by the general purpose terminal, and FIG. 4B is a flowchart that shows a processing executed by the AI image generation server. As shown in FIG. 4A, in a step S401, the CPU 301 of the general purpose terminal 102 determines that parameters related to an image to be generated by the AI image generation server 101 have been accepted from the user via the user I/F 304. The parameters are not particularly limited and may be, for example, keywords, texts, images, or the like related to the image that are used in publicly-known AI image generation techniques.

In a step S402, the CPU 301 transmits an image generation request based on the parameters in the step S401 to the AI image generation server 101 via the network I/F 305.

As shown in FIG. 4B, in a step S411, the CPU 201 of the AI image generation server 101 determines that the image generation request transmitted in the step S402 has been received via the network I/F 209.

In a step S412, as described above, the CPU 201 controls the GPU 207 to perform the AI image generation using the trained model 205 or the like.

In a step S413, the CPU 201 controls the AI identification information assigning unit 208 to assign identification information to metadata of image data that has been generated in the step S412. Hereinafter, the image data generated by the AI image generation may be referred to as “AI image data”. In addition, an AI image to which the identification information has been assigned may be referred to as “identification information-assigned image data”.

In a step S414, the CPU 201 transmits the image data, to which the identification information has been assigned in the step S413, to the general purpose terminal 102 via the network I/F 209. As a result, the general purpose terminal 102 is able to receive the identification information-assigned image data.

As described above, in the AI image generation server 101, the image data is obtained through the AI image generation (see the step S412). In addition, it is possible to, in the case that the identification information, which indicates that the image data has been obtained through the AI image generation, needs to be assigned to the image data, perform the assignment (see the step S413). The identification information-assigned image data is received by the general purpose terminal 102 via the network I/F 305, which functions as an obtaining unit that is able to obtain the identification information-assigned image data from the AI image generation server 101. The identification information-assigned image data is then displayed as an image on the touch panel of the user I/F 304 of the general purpose terminal 102. At this time, the user of the general purpose terminal 102 is able to refer to the metadata of the image data and confirm the identification information that has been assigned to the metadata on the touch panel. Through this confirmation, the user of the general purpose terminal 102 is able to understand that the image displayed on the touch panel includes an AI image. As a result, the user of the general purpose terminal 102 is able to, for example, suspect for the time being that the AI image is a fake image.

### Second Embodiment

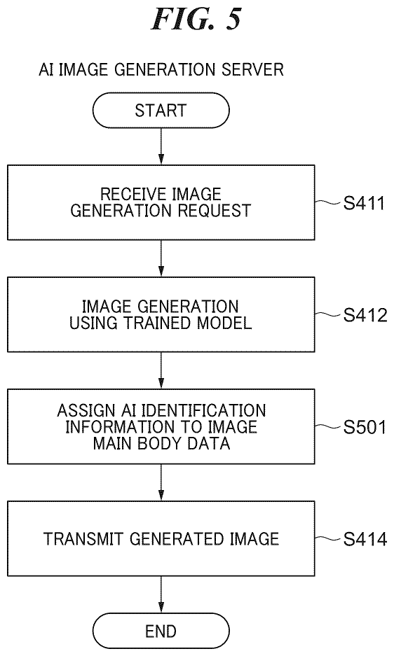

Hereinafter, a second embodiment will be described with reference to FIGS. 5 to 7D. The differences from the above-described first embodiment will be mainly described, and descriptions of similar matters will be omitted. The second embodiment is similar to the above-described first embodiment, except that the AI identification information assigning unit assigns the identification information to the image main body data out of the image main body data and the metadata that are included in the image data. FIG. 5 is a flowchart that shows a processing executed by an AI image generation server according to the second embodiment. In the flowchart shown in FIG. 5, the processing is executed in the order of the step S411, the step S412, a step S501, and the step S414. The steps S411, S412, and S414 are similar to the steps S411, S412, and S414 in the flowchart shown in FIG. 4B. In the step S501, the CPU 201 of the AI image generation server 101 controls the AI identification information assigning unit 208 to assign identification information to image main body data of image data that has been generated in the step S412. As a result, identification information- assigned image data is obtained.

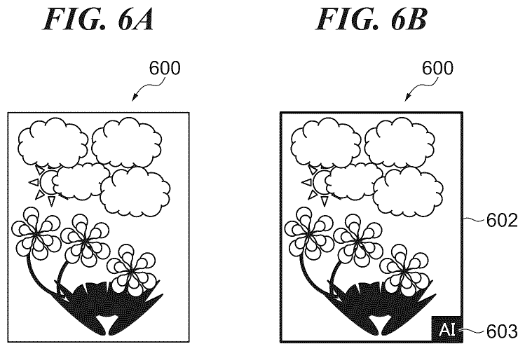

FIG. 6A and FIG. 6B are diagrams that show examples of an image of image data. An image 600 shown in FIG. 6A is an image of the image main body data included in the AI image data that has been obtained by the AI image generation in the step S412. An image 601 shown in FIG. 6B is an image of the identification information-assigned image data, to which the identification information has been assigned to the image main body data in the step S501. The image 601 has an image frame 602 and characters “AI” 603 that are superimposed on the image 601 as the identification information indicating that it is an AI-generated image. As a result, in the case that the user visually recognizes the image 601 on the touch panel of the user I/F 304 of the general purpose terminal 102, the user is able to understand that the image 601 is an AI image. It should be noted that although the characters 603 are “AI”, they are not limited to this and may be any characters that indicate that the image is an AI generated image.

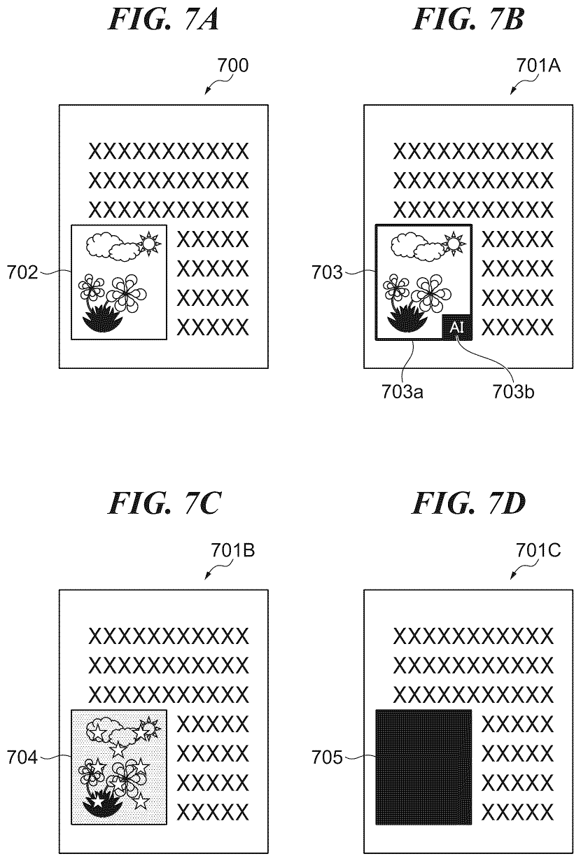

FIGS. 7A, 7B, 7C, and 7D are diagrams that show examples of variations of an image of image data. An image 700 shown in FIG. 7A is an image of the image main body data included in the AI image data that has been obtained by the AI image generation in the step S412. The image 700 includes a partial image 702 that is an AI-generated image. An image 701A shown in FIG. 7B is an image of the identification information-assigned image data, to which the identification information has been assigned to the partial image 702 in the step S501. The image 701A includes a partial image 703. The partial image 703 is an image on which an image frame 703a and characters “AI” 703b are superimposed as the identification information indicating that the partial image 702 is an AI-generated image. An image 701B shown in FIG. 7C is an image of the identification information-assigned image data, to which the identification information has been assigned to the partial image 702 in the step S501. The image 701B includes a partial image 704. The partial image 704 is an image on which a very light color is applied over the entire partial image 704 as the identification information indicating that the partial image 702 is an AI-generated image, or on which marks such as star marks are superimposed as the identification information indicating that the partial image 702 is an AI-generated image. An image 701C shown in FIG. 7D is an image of the identification information-assigned image data, to which the identification information has been assigned to the partial image 702 in the step S501. The image 701C includes a partial image 705. The partial image 705 is an image filled with black as the identification information indicating that the partial image 702 is an AI-generated image. As a result, by confirming the partial image 703 of the image 701A, the partial image 704 of the image 701B, and the partial image 705 of the image 701C, the user is able to understand that the images 701A to 701C all include AI images. It should be noted that, for example, invisible information such as a digital watermark may be superimposed on the entire image or the partial image as the identification information indicating that it is an AI-generated image.

### Third Embodiment

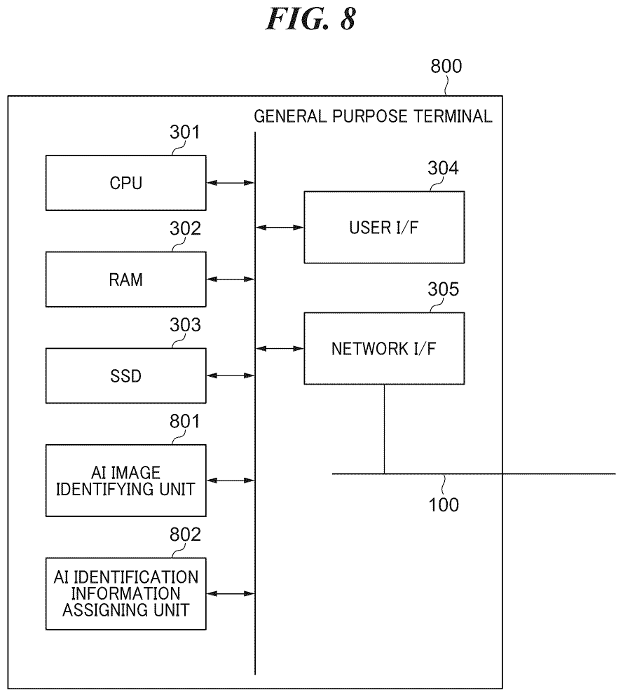

Hereinafter, a third embodiment will be described with reference to FIGS. 8 to 10. The differences from the above-described first embodiment will be mainly described, and descriptions of similar matters will be omitted. The third embodiment is similar to the above-described first embodiment, except that the generating unit that performs the AI image generation and the assigning unit that assigns the identification information are built into separate apparatuses.

FIG. 8 is a block diagram that shows a hardware configuration of a general purpose terminal according to the third embodiment. As in each of the above-described embodiments, a general purpose terminal 800 shown in FIG. 8 is an apparatus that is communicably connected to the AI image generation server 101, which is an external apparatus. In the third embodiment, in addition to the CPU 301, the RAM 302, the SSD 303, the user I/F 304, and the network I/F 305, the general purpose terminal 800 further includes an AI image identifying unit (a determining unit) 801 and an AI identification information assigning unit (an information assigning unit) 802. The network I/F 305 is able to obtain existing image data that has been generated by the AI image generation server 101 from the AI image generation server 101 (an obtaining step). As the existing image data, there are three types of image data: AI image data obtained by the AI image generation and before the identification information is assigned, identification information-assigned image data in a state where the identification information has been assigned to the AI image data, and non-AI image data not based on the AI image generation (non-AI image data not generated by the AI image generation).

The AI image identifying unit 801 determines whether or not the image data obtained by the network I/F 305 is image data generated by the AI image generation (a determining step). This determination is made based on the presence or absence of the identification information in the image data. In addition, the CPU 301 is able to function as a quantifying unit that quantifies a probability of a likelihood that the image data obtained by the network I/F 305 is data obtained by the AI image generation, that is, a probability, which indicates certainty, with a probability, a score, or the like. In this case, the AI image identifying unit 801 converts the probability into a percentage, and in the case that the numerical value of the probability is greater than or equal to a threshold value (N %), the AI image identifying unit 801 determines that the image data obtained by the network I/F 305 is image data generated by the AI image generation. In addition, in the case that the numerical value of the probability is less than the threshold value (N %), the AI image identifying unit 801 determines that the image data obtained by the network I/F 305 is not image data generated by the AI image generation. The threshold value may be stored in advance in the SSD (a storage unit) 303 or may be set appropriately via the user I/F (an operation unit) 304. Moreover, it is preferable that the threshold value is capable of being changed as appropriate via the user I/F 304. The AI identification information assigning unit 802 is capable of performing the processing similar to that of the AI identification information assigning unit 208 of the AI image generation server 101. Specifically, as a result of the determination by the AI image identifying unit 801, in the case of being determined that the image data is image data generated by the AI image generation, the AI identification information assigning unit 802 is capable of assigning the identification information to the image data (an information assigning step). In addition, the AI identification information assigning unit 802 may assign the probability.

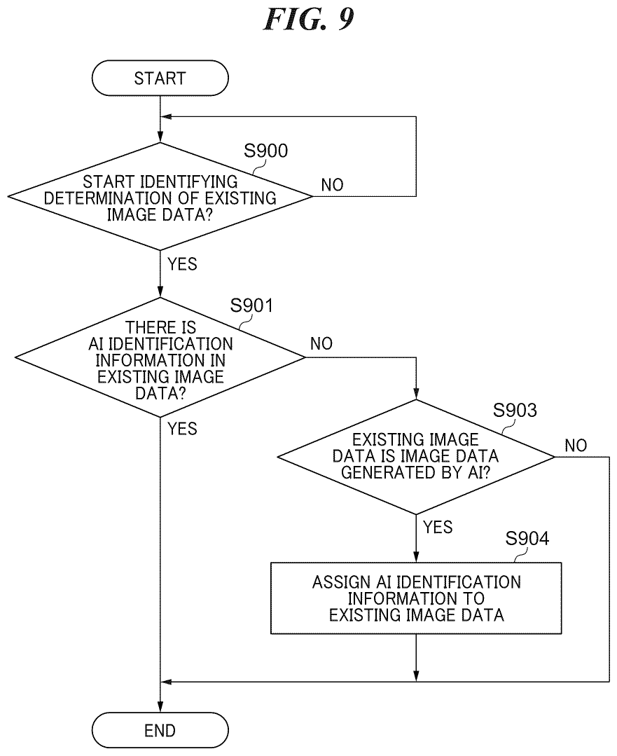

FIG. 9 is a flowchart that shows a processing (an AI image identifying processing) executed by the general purpose terminal according to the third embodiment. As shown in FIG. 9, in a step S900, the CPU 301 determines whether or not an identification start button (not shown) for determining whether or not the image data obtained by the network I/F 305 is image data generated by the AI image generation has been operated, that is, the identification start button has been pressed. The identification start button is, for example, provided on the user interface 304 (the user I/F 304). As a result of the determination in the step S900, in the case of being determined that the identification start button has been operated, the AI image identifying processing proceeds to a step S901. On the other hand, as the result of the determination in the step S900, in the case of being determined that the identification start button has not been operated, the AI image identifying processing remains at the step S900 and waits.

In the step S901, the CPU 301 controls the AI image identifying unit 801 to determine whether or not the identification information has been assigned to the image data obtained by the network I/F 305. As a result of the determination in the step S901, in the case of being determined that the identification information has been assigned to the image data obtained by the network I/F 305, the AI image identifying processing ends. In this case, the image data obtained by the network I/F 305 is stored in the SDD 303 as is. On the other hand, as the result of the determination in the step S901, in the case of being determined that the identification information has not been assigned to the image data obtained by the network I/F 305, the AI image identifying processing proceeds to a step S903.

In the step S903, the CPU 301 controls the AI image identifying unit 801 to determine whether or not the image data obtained by the network I/F 305 is image data generated by the AI image generation. As a result of the determination in the step S903, in the case of being determined that the image data obtained by the network I/F 305 is image data generated by the AI image generation, the AI image identifying processing proceeds to a step S904. On the other hand, as the result of the determination in the step S903, in the case of being determined that the image data obtained by the network I/F 305 is not image data generated by the

AI image generation, the AI image identifying processing ends. In this case, the image data obtained by the network I/F 305 is stored in the SDD 303 as is.

In the step S904, the CPU 301 controls the AI identification information assigning unit 802 to assign the identification information to the image data obtained by the network I/F 305. The identification information may be assigned to the image main body data, the metadata, or both the image main body data and the metadata. After the step S904 has been executed, the AI image identifying processing ends. The image data to which the identification information has been assigned is stored in the SDD 303. It should be noted that in the flowchart shown in FIG. 9, the processing order of the steps S901 and S903 may be switched, that is, may be reversed.

In addition, as described above, as the existing image data obtained from the AI image generation server 101, there are three types of image data. The first type of image data is the AI image data obtained by the AI image generation and before the identification information is assigned. The second type of image data is the identification information-assigned image data in the state where the identification information has been assigned to the AI image data. The third type of image data is the non-AI image data not based on the AI image generation (the non-AI image data not generated by the AI image generation). In addition, in the determination in the step S901, the first type of image data is determined as “NO”, the second type of image data is determined as “YES”, and the third type of image data is determined as “NO”. Furthermore, in the determination in the step S903, the first type of image data is determined as “YES”, and the third type of image data is determined as “NO”.

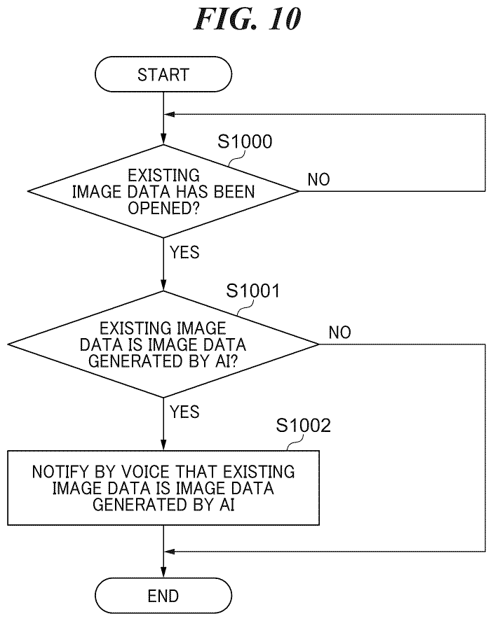

FIG. 10 is a flowchart that shows a processing (an AI image notifying processing) executed by the general purpose terminal according to the third embodiment. Here, it is assumed that the user interface 304 include a speaker. As shown in FIG. 10, in a step S1000, the CPU 301 determines whether or not a button (not shown) for opening the image data that has been stored in the SDD 303 during the processing of the flowchart shown in FIG. 9 has been operated. This button is, for example, provided on the user interface 304. As a result of the determination in the step S1000, in the case of being determined that the button has been operated, the AI image notifying processing proceeds to a step $1001. On the other hand, as the result of the determination in the step S1000, in the case of being determined that the button has not been operated, the AI image notifying processing remains at the step S1000 and waits.

In the step S1001, the CPU 301 controls the AI image identifying unit 801

to determine whether or not the image data to be opened in the step S1000 is image data generated by the AI image generation. This determination is made based on the presence or absence of the identification information. As a result of the determination in the step S1001, in the case of being determined that the image data to be opened in the step S1000 is image data generated by the AI image generation, the AI image notifying processing proceeds to a step S1002. On the other hand, as the result of the determination in the step S1001, in the case of being determined that the image data to be opened in the step S1000 is not image data generated by the AI image generation, the AI image notifying processing ends.

In the step S1002, the CPU 301 controls the speaker of the user interface 304 to notify by voice that the image data to be opened in the step S1000 is image data generated by the AI image generation. This notification allows the user to know that the image data is image data generated by the AI image generation before opening the image data. It should be noted that the notification target in the step S1002 is the image data that has been stored in the SDD 303 after the step S901 has been executed and the image data that has been stored in the SDD 303 after the step S904 has been executed. Furthermore, the notification performed by the user interface 304 is not limited to the notification by voice, but may be, for example, a notification by an image, a notification by light emission, a notification by vibration, or the like, or may be a notification by a combination of these. In addition, after the step S1002 has been executed, the CPU 301 may determine whether or not to forcibly open the image data to be opened in the step S1000. This determination is capable of being made based on, for example, the presence or absence of an operation with respect to a button provided on the user interface 304 for forcibly opening the image data. In addition, in the case that the button has been operated, the image data will be forcibly opened.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-007426. filed on Jan. 22, 2024, which is hereby incorporated by reference herein in its entirety.

What is claimed is:

1. An image processing apparatus comprising:
an obtaining unit configured to obtain an image;
a determining unit configured to determine whether or not the image obtained by the obtaining unit is an image generated based on a learning model; and
an assigning unit configured to, in a case of being determined by the determining unit that the image obtained by the obtaining unit is an image generated based on the learning model, assign, to the image obtained by the obtaining unit, an identification image indicating that the image obtained by the obtaining unit is an image generated based on the learning model.

2. The image processing apparatus according to claim 1, further comprising:
a generating unit configured to generate an image based on the learning model, and
wherein the obtaining unit obtains the image generated by the generating unit.

3. The image processing apparatus according to claim 1, wherein
the image processing apparatus is an apparatus that is communicably connected to an external apparatus comprising a generating unit configured to generate the image based on the learning model, and
the obtaining unit is capable of obtaining the image from the external apparatus.

4. The image processing apparatus according to claim 1, further comprising:
a quantifying unit configured to quantify a probability of a likelihood that the image is an image generated based on the learning model, and
wherein the determining unit determines that the image is an image generated based on the learning model in a case that a numerical value quantified by the quantifying unit is greater than or equal to a threshold value, and determines that the image is not an image generated based on the learning model in a case that the numerical value is less than the threshold value.

5. The image processing apparatus according to claim 4, further comprising:
a storage unit configured to store the threshold value; and
an operation unit configured to perform an operation to change the threshold value.

6. The image processing apparatus according to claim 1, wherein
the image includes metadata.

7. The image processing apparatus according to claim 1, wherein
the assigning unit assigns, as the identification image, at least one of information indicating that the image is output data outputted from the learning model, input data to be inputted into the learning model when the output data is outputted, the learning model, a program using the learning model, and a probability of a likelihood that the image is an image generated based on the learning model.

8. A control method for controlling an image processing apparatus, the control method comprising:
an obtaining step of obtaining an image;
a determining step of determining whether or not the image obtained in the obtaining step is an image generated based on a learning model; and
an assigning step of, in a case of being determined in the determining step that the image obtained in the obtaining step is an image generated based on the learning model, assigning, to the image obtained in the obtaining step, an identification image indicating that the image obtained in the obtaining step is an image generated based on the learning model.

9. A non-transitory computer-readable storage medium storing a program for causing a computer to execute a control method for an image processing apparatus,
the control method comprising:
an obtaining step of obtaining an image;
a determining step of determining whether or not the image obtained in the obtaining step is an image generated based on a learning model; and
an assigning step of, in a case of being determined in the determining step that the image obtained in the obtaining step is an image generated based on the learning model, assigning, to the image obtained in the obtaining step, an identification image indicating that the image obtained in the obtaining step is an image generated based on the learning model.
